(19) United States
(12) Patent Application Publication
(10) Pub. No.: US 2015/0370420 A1
(43) Pub. Date: Dec. 24, 2015

(54) METHOD FOR QUICK EXECUTION OF AN OPTION

(71) Applicant: WALTON ADVANCED ENGINEERING INC., Kaohsiung (TW)

(72) Inventors: Hong Chi YU, Kaohsiung (TW); Mao Ting CHANG, Kaohsiung (TW)

(73) Assignee: WALTON ADVANCED ENGINEERING INC., Kaohsiung (TW)

(21) Appl. No.: 14/483,778

(22) Filed: Sep. 11, 2014

(30) Foreign Application Priority Data
Jun. 19, 2014 (TW) 103121154

(51) Int. Cl. G06F 3/0482; G06F 3/0484; H04L 29/08; G06F 17/30

(52) U.S. Cl. CPC G06F 3/0482; G06F 17/30126; G06F 3/04842; H04L 67/02; G06F 17/30076

(57) ABSTRACT

A main remote application menu in a local device provides a user with multiple mechanisms by which the user effectively and quickly share and transform files (text, music, video, etc.). The main remote application menu can be used in fast sharing of a data file, data transformation and other data options for provision of associated functions related to the format of a corresponding file compared with that of the data file.

### BACKGROUND OF THE INVENTION

1) Field of the Invention

The present disclosure relates to an interactive interface between a local device and a remote unit, particularly a method of providing a user interface menu for an operating system.

2) Description of the Prior Art

The cloud concept which is considered as another great change after the previous one from the mainframe to the small server in 1980s has emerged recently when users need not to familiarize themselves with detailed hardware facilities and expertise or to execute direct control.

In this regard, the emerging software service model arising from this change provides sufficient software and data in remote equipment accessible to ordinary users for multiple services based on neither installation of specific software nor booting of a local computer or employment of local resources.

There have been several patents for interface interaction and remote service disclosed as follows:

TW I370669 disclosed a programmable real-time interactive menu system for a mobile device which is divided into two parts including a handheld device and an application service platform: the hand-held device comprises a client service platform, a client service module and a client service menu module; the application service platform comprises a server service platform and a server service module for linking other service systems; the client service platform coordinately interacts with the server service platform to complete services or enable applications in the handheld device for a user who activates the client service menu module; an adequate client service module will be automatically downloaded to and installed in the handheld device in which no alternative client service module available to a user; a customized or personalized layout function via the interactive client service menu module will be available to a user.

TW 201337592 disclosed an OS application launch menu (e.g., start menu) by which a user accesses multiple mechanisms for quick efficient positioning and activation of desired items (such as program, data file, storage location, etc.). A user is able to fast locate programs, files, communications or others with a search box in the application launch menu or an automated completion attribute (in the case of restrictive strings entered by the user for searches). A most commonly used program list depends on different criteria such as frequency of use and two most recently used items to incorporate programs and thereby comprises a most recently used item. All programs and files in an all program view can be displayed on a hosted-tree view in the original application launch menu without requirements of opening submenus over the desktop of the display unit.

TW I313996 disclosed a method of guiding a client to securely link a server via a public network, characterized in that a public key authenticated by the server and another public key as well as a Remote Service Unique ID (RSUID) authenticated by the client are exchanged by the server and the client during registration. The method comprises steps as follows: a client information packet with RSUID included as well as a client challenge information packet encoded with the public key authenticated by the server are delivered to the server; a server information packet with RSUID included, a server challenge information packet, and a part of the client challenge information packet encoded with the public key authenticated by the client are received by the server; the server challenge information packet is decoded and verified with a private key authenticated by the client; the encoded part of the client challenge information packet received is delivered to the server.

TW 201403351 disclosed a work-based method, device and computer program product for accessing functions provided by one or more remote services. In an embodiment, the method presents a work-based query which gives hints for works to be done. The method further provides the work-based query to a remote service search engine. For a plurality of remote services, the method further comprises a remote service instruction which is configured to execute works from the remote service search engine and comprises a command to query the remote service.

However, the issue to be settled quickly is to provide users enjoying convenient cloud services with remote service, optimal user experience locally, and diversified services for different types of files.

Thus, the present disclosure is intended to provide a method of quick execution of an option for settling the abovementioned issue,

### SUMMARY OF THE INVENTION

For the above problems, a method for quick execution of an option in the present disclosure is based on a file menu for completion of data management in a local device originally by means of supports of remote resources.

A method for quick execution of an option is intended to reduce processing time via interactions between a local file menu and a remote unit.

A method for quick execution of an option is intended to provide best services by means of menus for different types of files.

A method for quick execution of an option is intended to reduce network loading of a local device with shared data temporarily saved in a remote unit.

A method for quick execution of an option is intended to access data which is shared by a local device off-line but temporarily saved in a remote unit.

A method for quick execution of an option is intended to transform files by means of remote services.

A method for quick execution of an option is intended to reduce costs of installing software in a local device by means of a file menu.

A method for quick execution of an option depends on the following technical measures to realize the above purposes. A method for quick execution of an option for interactions between a local device and a remote unit comprises steps as follows: (a) step 1: a main remote application menu is indicated on a display unit, which is directly or indirectly connected to a local device, and created in a single browsing step when a menu bar for a data file is activated in the local device with a mouse, a keyboard or a touchpad connected by a user, who may right click on the data file in the local device with the mouse, press a menu key on the data file of the local device with the keyboard, or tap and hold the data file of the local device via the touchpad; step 2: a duplicated option, which is a menu option reproducing the data file to a storage device of the designated remote unit, and at least a type-relevant option are provided to a user by the main remote application menu according to the type of the data file and the user intuitively make a choice from the duplicated option or the type-relevant option in the main remote application menu without other complicated operations; step 3: an alert message is indicated on the display unit and automatically closed after a brief period when the duplicated option or the type-relevant option is clicked.

The purposes of a method for quick execution of an option for technical issues are further realized with the following technical measures.

In the method for quick execution of an option, the duplicated option is also a menu option by which the data file is temporarily saved in the storage device of the remote unit and a shared link URL is reproduced.

In the method for quick execution of an option, the type-relevant option is a menu option by which the data file is temporarily saved in the storage device of the remote unit and the format of the data file is transformed by the remote unit.

In the method for quick execution of an option, a corresponding request for authentication, upload, message interaction and execution is provided to the remote unit by a middle program of the local device during step 2 in which a user clicks on the duplicated option or the type-relevant option.

In the method for quick execution of an option, the storage device in the designated remote unit for the duplicated option in step 2 is configured with a management interface on the remote unit.

In the method for quick execution of an option, the alert message created by the middle program and visually indicated on the display unit in step 3 can be cancelled and not executed optionally.

In the method for quick execution of an option, the remote unit completing transmission of the data file with the duplicated option clicked by a user will reply a message after step 3 so that a regular message created by the middle program is indicated on the display unit and presents information of a download link URL.

In the method for quick execution of an option, the remote unit completing transformation of the format of the data file with the type-relevant option clicked by a user will reply an alternative message after step 3 so that a regular message created by the middle program is indicated on the display unit and presents information of a download link URL.

In contrast to prior arts, the method for quick execution of an option has some advantages: (1) file sharing function; (2) flexible menus based on types of files; (3) high stability during transformation of data in dedicated facilities.

### BRIEF DESCRIPTIONS OF THE DRAWINGS

FIG. 1 is a flow chart for a first method which illustrates a method for quick execution of an option in a preferred embodiment;

FIG. 2a is a first schematic view which illustrates a method for quick execution of an option in a preferred embodiment;

FIG. 2b is a second schematic view which illustrates a method for quick execution of an option in a preferred embodiment;

FIG. 3 is a third schematic view which illustrates a method for quick execution of an option in a preferred embodiment;

FIG. 4 is a flow chart for a second method which illustrates a method for quick execution of an option in a preferred embodiment;

FIG. 5 is a fourth schematic view which illustrates a method for quick execution of an option in a preferred embodiment;

FIG. 6 is a fifth schematic view which illustrates a method for quick execution of an option in a preferred embodiment; and

FIG. 7 is a sixth schematic view which illustrates a method for quick execution of an option in a preferred embodiment.

### DETAILED DESCRIPTIONS OF THE PREFERRED EMBODIMENTS

The preferred embodiments of a method for quick execution of an option are particularly described hereinafter for understanding purposes, features and effects.

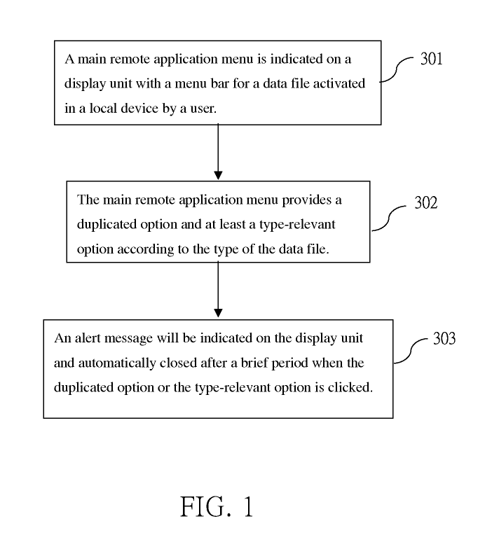

FIG. 1 through FIG. 7 illustrate the preferable embodiments of a method for quick execution of an option. Referring to FIG. 1 which illustrates principal steps comprising step 1 (301), step 2 (302) and step 3 (303).

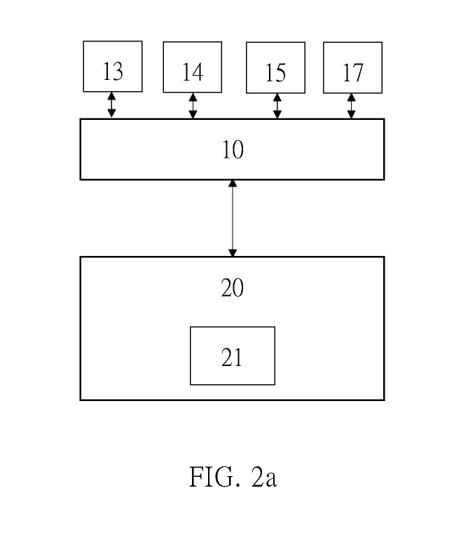

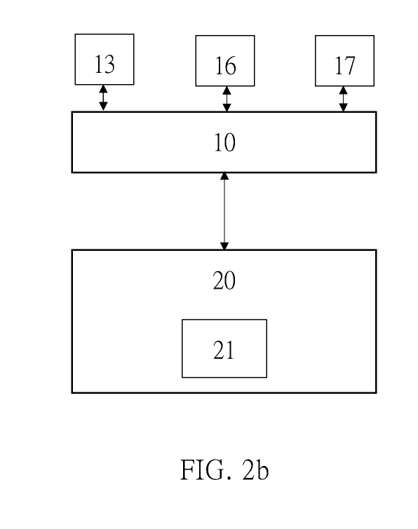

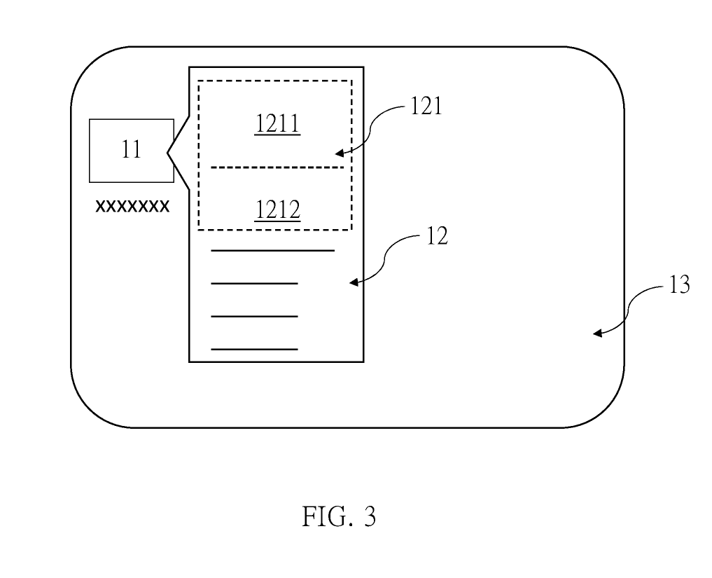

For step 1 (301), referring to FIGS. 2a, 2b and 3. A main remote application menu (121) is indicated on a display unit (13) with a menu bar (12) for a data file (11) activated in a local device (10) by a user.

FIGS. 2a and 3 illustrate detailed relationships among components after step 1 (301) for the display unit (13), a mouse (14) and a keyboard (15) directly or indirectly connected to the local device (10), characterized in that a step to display a main remote application menu (121) on the display unit (13) is a single browsing step executed by a user who may either right clicks on the data file (11) in the local device (10) with the mouse (14) or presses a menu key on the data file (11) of the local device (10) with the keyboard (15).

FIGS. 2b and 3 illustrate further detailed relationships among components after step 1 (301) for the display unit (13) and a touchpad (16) directly or indirectly connected to the local device (10), characterized in that a step to display the main remote application menu (121) on the display unit (13) is a single browsing step executed by a user who taps and holds the data file (11) of the local device via the touchpad (16).

Specifically, the local device (10) is a computer with a graphic user interface, the data file (11) contains data saved in the local device (10), and the menu bar (12) is one component on the graphic user interface from which a user can make a choice among associated options.

Referring to FIGS. 1 and 3 again for step 2 (302); the main remote application menu (121) provides a duplicated option (1211) and at least a type-relevant option (1212) according to the type of the data file (11).

Specifically, a user intuitively makes a choice from the duplicated option (1211) or the type-relevant option (1212) in the main remote application menu (121) in step 2 without other complicated operations.

The duplicated option (1211) is a menu option by which the data file (11) can be reproduced to a storage device (21) in the designated remote unit (20); the storage device (21) in the designated remote unit (20) for the duplicated option (1211) is configured with a management interface on the remote unit (20) such as a web page mostly or a user interface presented with a program; preferably, the duplicated option (1211) is also a menu option by which the data file (11) is temporarily saved in the storage device (21) of the remote unit (20) and a shared link URL (211) is reproduced in memories/storage spaces in the local device (10).

The type-relevant option (1212) is a menu option by which the data file (11) is temporarily saved in the storage device (21) of the remote unit (20) and the format of the data file (11) is transformed by the remote unit (20); the format of the data file (11) to which data from the remote unit (20) is provided can be transformed with a corresponding processing program designated by the remote unit (20) for reduced data processing at associated software and hardware installed in the local device (10).

Referring to FIGS. 1, 3 and 5 again for step 3 (303); an alert message (131) will be indicated on the display unit (13) and automatically closed after a brief period when the duplicated option (1211) or the type-relevant option (1212) is clicked.

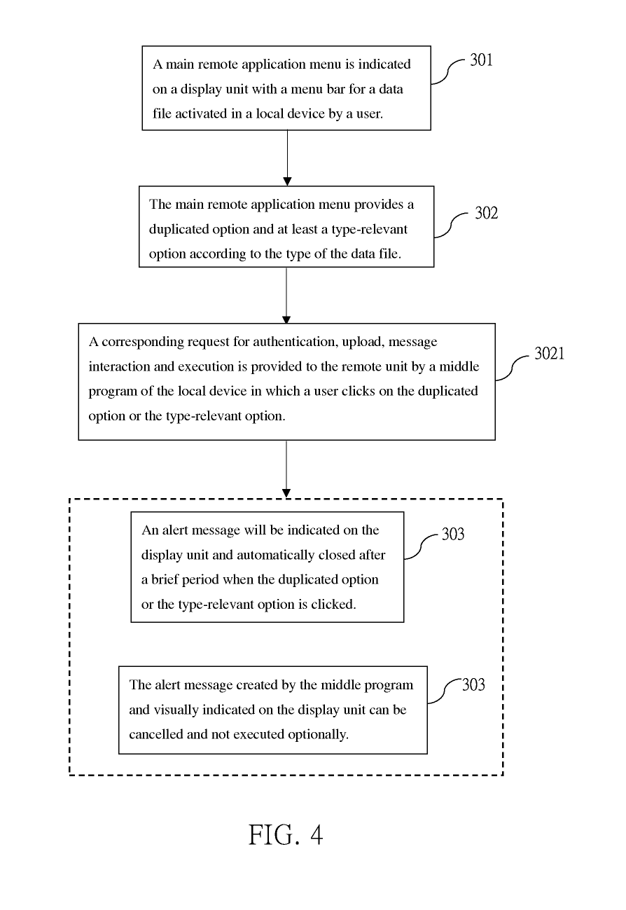

Preferably, an extra step of step 2-1 (3021) is added between step 2 (302) and step 3 303), which is executed with step 3-1 (3031) simultaneously, as shown in FIG. 4.

Step 2-1 (3021) following step 2 (302) in which a user clicks on the duplicated option (1211) or the type-relevant option (1212) depends on a middle program (16) in the local device (10) to issue a corresponding request for authentication, upload, message interaction and execution; the middle program (16) is a program configured in a specific area of memories within a computer and called by a user anytime.

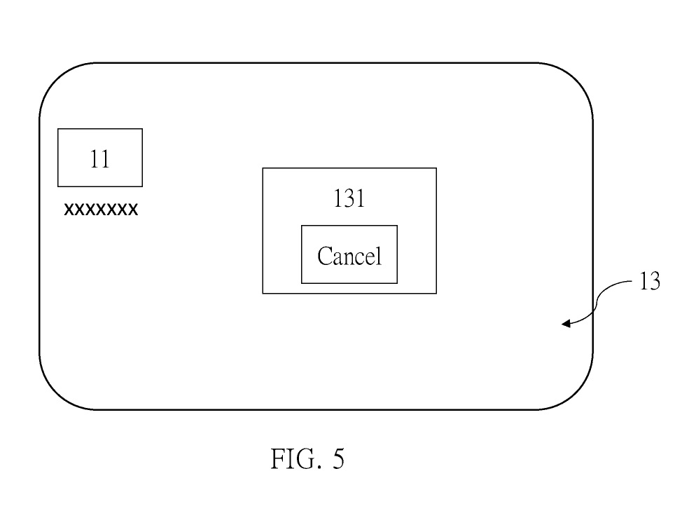

As shown in FIG. 5, step 3-1 (3031) supplemented to step 3 (303) allows the alert message (131) created by the middle program (16) and visually indicated on the display unit (13) to be cancelled and not executed optionally in case of a wrong choice made by a user.

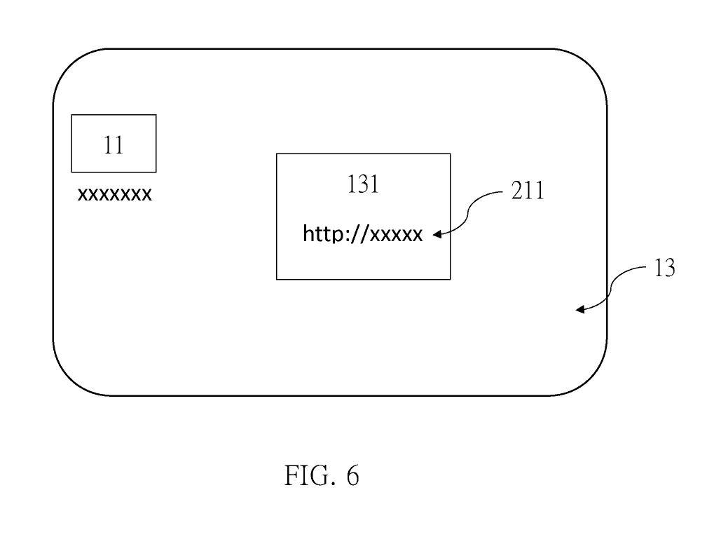

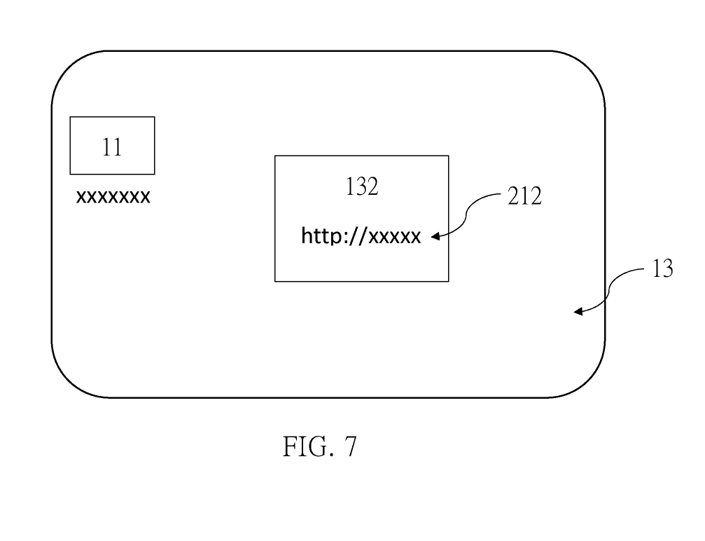

For a user's preferable experience, the remote unit (20) completing transmission of the data file (11) with the duplicated option (1211) clicked by a user will reply a message after step 3 (303) so that a regular message (131) created by the middle program (16) is indicated on the display unit (13) and presents information of a download link URL (211) to be shared and employed by a user, as shown in FIG. 6; the remote unit (20) completing transformation of the format of the data file (11) with the type-relevant option (1212) clicked by a user will reply an alternative message after step 3 (303) so that a regular message (132) created by the middle program (16) is indicated on the display unit (13) and presents information of a download link URL (212) as a hint of the transformation completed and download available, as shown in FIG. 7.

Accordingly, the method in the present disclosure, which differs from other conventional methods for remote applications, is referred to as creative work that meets patentability and is applied for the patent.

It should be reiterated that the above descriptions presents preferred embodiments, and any equivalent change in specifications, claims, or drawings still belongs to the technical field within the present disclosure with reference to claims hereinafter.

What is claimed is:

1. A method for quick execution of an option used in interactions between a local device (10) and a remote unit (20), comprising steps as follows:
step 1: a main remote application menu (121) is indicated on a display unit (13), which is directly or indirectly connected to a local device (10), and created in a single browsing step when a menu bar (12) for a data file (11) is activated in the local device (10) with a mouse (14), a keyboard (15) or a touchpad (16) connected by a user, who may right click on the data file (11) in the local device (10) with the mouse (14), press a menu key on the data file (11) of the local device (10) with the keyboard (15), or tap and hold the data file (11) of the local device (10) via the touchpad (16);
step 2: a duplicated option (1211), which is a menu option reproducing the data file (11) to a storage device (21) of the designated remote unit (20), and at least a type-relevant option (1212) are provided to a user by the main remote application menu (121) according to the type of the data file (11) and the user intuitively make a choice from the duplicated option (1211) or the type-relevant option (1212) in the main remote application menu (121) without other complicated operations;
step 3: an alert message (131) is indicated on the display unit (13) and automatically closed after a brief period when the duplicated option (1211) or the type-relevant option (1212) is clicked.

2. A method for quick execution of an option according to claim 1, characterized in that the duplicated option (1211) is a menu option by which the data file (11) is temporarily saved in the storage device (21) of the remote unit (20) and a shared link URL (211) is reproduced.

3. A method for quick execution of an option according to claim 1, characterized in that the type-relevant option (1212) is a menu option by which the data file (11) is temporarily saved in the storage device (21) of the remote unit (20) and the format of the data file (11) is transformed by the remote unit (20).

4. A method for quick execution of an option according to claim 1, characterized in that a corresponding request for authentication, upload, message interaction and execution is provided to the remote unit (20) by a middle program (17) of the local device (10) during step 2 in which a user clicks on the duplicated option (1211) or the type-relevant option (1212)

5. A method for quick execution of an option according to claim 1, characterized in that the storage device (21) in the designated remote unit (20) for the duplicated option (1211) in step 2 is configured with a management interface on the remote unit (20).

6. A method for quick execution of an option according to claim 4, characterized in that the alert message (131) created by the middle program (17) and visually indicated on the display unit (13) in step 3 can be cancelled and not executed optionally.

7. A method for quick execution of an option according to claim 4, characterized in that the remote unit (20) completing transmission of the data file (11) with the duplicated option (1211) clicked by a user will reply a message after step 3 so that a regular message (131) created by the middle program (17) is indicated on the display unit (13) and presents information of a download link URL (211).

8. A method for quick execution of an option according to claim 4, characterized in that the remote unit (20) completing transformation of the format of the data file (11) with the type-relevant option (1212) clicked by a user will reply an alternative message after step 3 so that a regular message (132) created by the middle program (17) is indicated on the display unit (13) and presents information of a download link URL (212).
